(19) United States
(12) Patent Application Publication
(10) Pub. No.: US 2019/0301680 A1
(43) Pub. Date: Oct. 3, 2019

(54) CRYOGENIC LIQUID DISPENSING DEVICE

(71) Applicants: Steven Canyon, ASHEVILLE, NC (US); Megan Canyon, ASHEVILLE, NC (US)

(72) Inventors: Steven Canyon, ASHEVILLE, NC (US); Megan Canyon, ASHEVILLE, NC (US)

(21) Appl. No.: 16/297,609

(22) Filed: Mar. 9, 2019

Related U.S. Application Data
(60) Provisional application No. 62/649,383, filed on Mar. 28, 2018.

(51) Int. Cl. F17C 9/02; F17C 13/02; F17C 13/04; F17C 13/00

(52) U.S. Cl. CPC F17C 9/02; F17C 2270/0509; F17C 13/021; F17C 13/04; F17C 13/006; F17C 2201/0109; F17C 2201/032; F17C 2203/0629; F17C 2205/0329; F17C 2205/0326; F17C 2205/0332; F17C 2205/0335; F17C 2205/0352; F17C 2205/0394; F17C 2221/014; F17C 2223/013; F17C 2227/0304; F17C 2250/0408; F17C 2250/043; F17C 13/025

(57) ABSTRACT

A cryogenic liquid dispensing device may include a cryogenic cylinder for containing a cryogenic liquid. A dispensing pipe may be in fluid communication with the cryogenic cylinder. A dispensing valve may be configured to govern the fluid communication between the dispensing pipe and the cryogenic cylinder. A heating element may be disposed within the cryogenic cylinder, and the heating element may be configured to generate heat within the cryogenic cylinder to increase the pressure within the cryogenic cylinder. By generating heat within the cryogenic cylinder, the pressure within the cylinder may be increased and used to motivate a cryogenic fluid within the cylinder to the dispensing valve and out of the dispensing pipe. Preferably, the device may include a processing unit that may be configured to cause the heating element to generate heat within the cryogenic cylinder when a pressure reader detects a minimum pressure within the cryogenic cylinder.

### CROSS REFERENCE TO RELATED APPLICATIONS

This application claims priority to and the benefit of the filing date of U.S. Provisional Application No. 62/649,383, filed on Mar. 28, 2018, entitled “HEAT BASED MANUAL PRESSURIZING LIQUID NITROGEN DISPENSING SYSTEM”, which is hereby incorporated by reference in its entirety.

### FIELD OF THE INVENTION

This patent specification relates to the field of cryogenic liquid dispensing devices. More specifically, this patent specification relates to a self-pressurizing device for storing and dispensing cryogenic liquids such as nitrogen.

### BACKGROUND

The application of cryogenic technology typically utilizes self-pressurizing cylinders to dispense either gas or liquid. The typical method uses liquid to gas conversion, or evaporation, to create pressure within a cylinder which is then used to dispense the cryogenic liquid or gas within the cylinder.

The most commonly available systems for dispensing cryogenic liquids, such as nitrogen, are self-pressurizing cylinders, which tend to be cumbersome and utilize various cryogenic hoses and pipes. These systems are not typically created for use in areas of general public egress and have many drawbacks, especially when considering that they lack simplicity of use and have other safety concerns.

U.S. Pat. No. 4,608,831 describes Self Pressurizing Cryogenic tanks that are only suitable for occasional and one-time uses. These tanks often become over-frozen when valves are turned on and off repeatedly, sometimes causing valves to dangerously freeze in the open position. Self-pressurizing cryogenic tanks also frequently and quite loudly vent to automatically release pressure caused from the natural liquid to gas conversion an average rate of 2.3% per day. The loud venting process is startling and worrisome in retail, general public situations and within medical facilities.

Another prominent invention in the field of cryogenic dispensing systems, is the static dewar, such as described in U.S. Pat. No. 3,119,238. There are two ways to dispense liquid nitrogen from a static dewar. One, is using a stainless-steel dipper or ladle. This method is slow and considered to be awkward—a process which is not ideal for fast and on-demand dispensing purposes. The second way to dispense liquid nitrogen from a static dewar is via a withdrawal device similar to the one described in U.S. Pat. No. 5,488,831. This device relies on the natural evaporation of liquid nitrogen to create a pressure value high enough within the device that is usable for dispensing liquid nitrogen. However, frequent and high-volume use can result in the quick depletion of pressure, increasing the possibility of not being able to dispense liquid nitrogen until the pressure has been restored through evaporation.

Therefore, a need exists for novel cryogenic dispensing systems and devices which fix the issues that currently exist with cryogenic dispensing systems. A further need exists for novel cryogenic dispensing systems and devices which offer portability, manual operator-controlled pressurization for quick, on-demand use, incorporating multiple safety precautions, and since the user is controlling the pressure, there is no pressure releasing cryogenic venting or loss of desirable operative pressure. Additionally, a need exists for novel cryogenic dispensing systems and devices which when not in use, the pressure is released which disables the cylinders ability to dispense liquid nitrogen. In areas where the general public could have access to the cylinder, this is ideal. For example, a person could not turn on a valve and dispense liquid nitrogen when the unit is unsupervised and depressurized.

### BRIEF SUMMARY OF THE INVENTION

A cryogenic liquid dispensing device is provided. In preferred embodiments, the device may be a heat based manual pressurizing liquid nitrogen dispensing device that contains all of the necessary cryogenic equipment needed to electronically monitor, pressurize and dispense cryogenic liquids, such as liquid nitrogen, all preferably contained in an aesthetically pleasing safety barrier configured as powder coated steel box. This device solves the problem of the unpredictability of using self-pressurizing cryogenic cylinders that depend upon the evaporation of cryogenic liquids for the generation of operational pressure in order to dispense cryogenic liquids, such as liquid nitrogen. Additionally, the device is able to centralize the cryogenic technology into an appliance format with predictable operational results rather than using existing cryogenic equipment which is typically cumbersome, bulky and which regularly vents while producing a loud hissing noise which is an undesirable feature in most professional and retail settings of general public egress.

In some embodiments, the device may include a cryogenic cylinder which may be used for containing a cryogenic liquid. A dispensing pipe may be in fluid communication with the cryogenic cylinder. A dispensing valve may be configured to govern the fluid communication between the dispensing pipe and the cryogenic cylinder. A heating element may be disposed within the cryogenic cylinder, and the heating element may be configured to generate heat within the cryogenic cylinder to increase the pressure within the cryogenic cylinder. By generating heat within the cryogenic cylinder, the pressure within the cylinder may be increased and used to motivate a cryogenic fluid within the cylinder to the dispensing valve and out of the dispensing pipe.

In further embodiments, the device may include a pressure reader that may be configured to detect a pressure within the cryogenic cylinder.

In still further embodiments, the device may include a liquid level reader that may be configured to detect the level of the cryogenic liquid within the cryogenic cylinder.

In yet further embodiments, the device may include a processing unit that may be configured to cause the heating element to generate heat within the cryogenic cylinder when the pressure reader detects a minimum pressure within the cryogenic cylinder, and/or the processing unit may be configured to cause the heating element to stop generating heat within the cryogenic cylinder when the pressure reader detects a maximum pressure within the cryogenic cylinder.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a front perspective view of an example of a cryogenic liquid dispensing device having an access door in a closed position according to various embodiments described herein.

FIG. 2 illustrates a front perspective view of an example of a cryogenic liquid dispensing device having an access door in an open position according to various embodiments described herein.

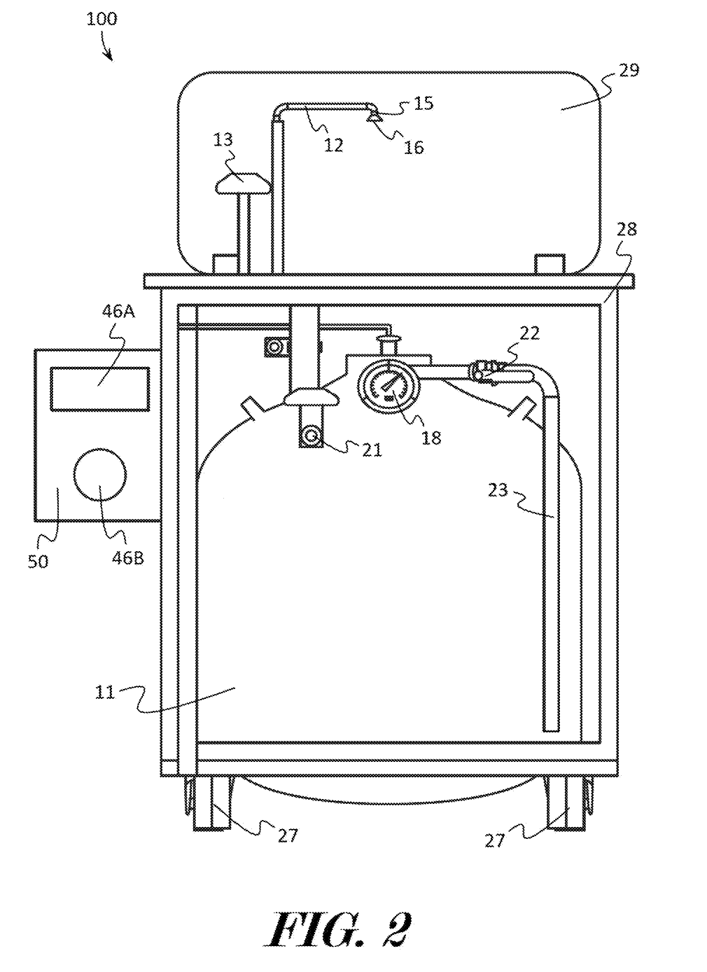

FIG. 3 shows a rear perspective view of an example of a cryogenic liquid dispensing device having a side table in an extended position according to various embodiments described herein.

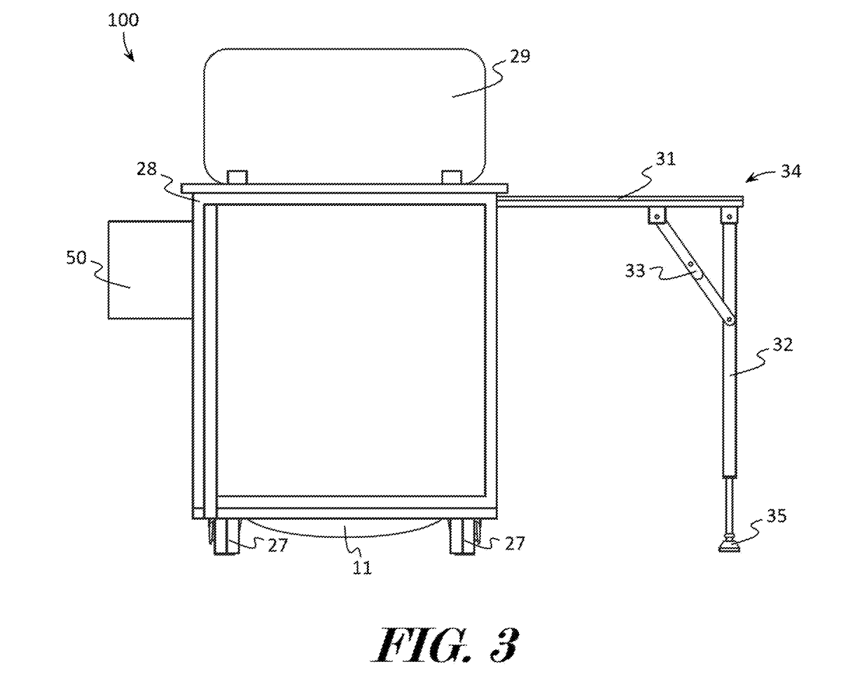

FIG. 4 depicts a sectional elevation view of an example cryogenic cylinder according to various embodiments described herein.

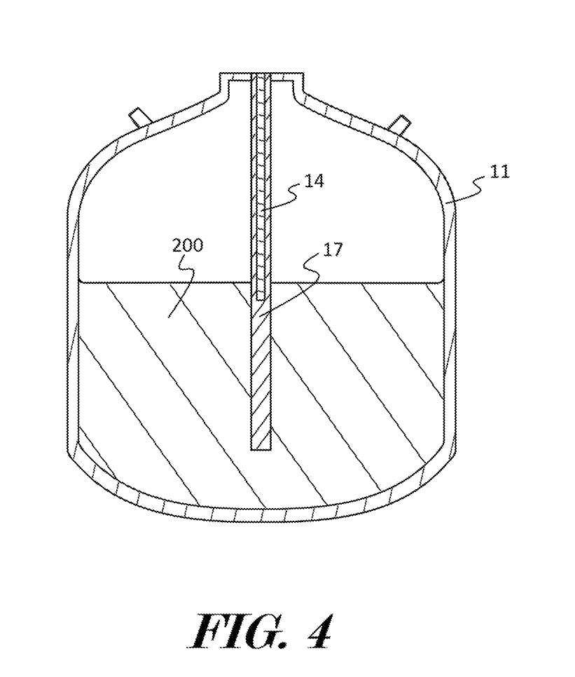

FIG. 5 illustrates a block diagram of an example of a processing unit according to various embodiments described herein.

FIG. 6 shows a schematic diagram of an example of a cryogenic liquid dispensing device according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

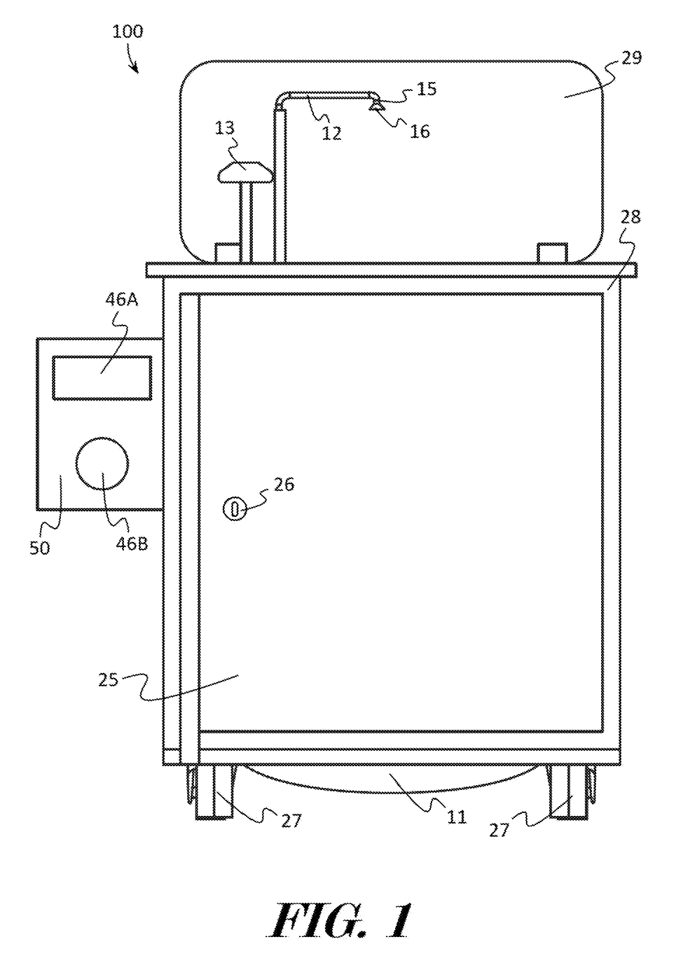

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

A new cryogenic liquid dispensing device is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

The present invention will now be described by example and through referencing the appended figures representing preferred and alternative embodiments. FIG. 1 illustrates an example of a cryogenic liquid dispensing device (“the device”) 100 according to various embodiments. In some embodiments, the device 100 may comprise a cryogenic cylinder 11 which may be used for containing a cryogenic liquid 200. A dispensing pipe 12 may be in fluid communication with the cryogenic cylinder 11. A dispensing valve 13 may be configured to govern the fluid communication between the dispensing pipe 12 and the cryogenic cylinder 11. A heating element 14 may be disposed within the cryogenic cylinder 11, and the heating element 14 may be configured to generate heat within the cryogenic cylinder 11 to increase the pressure within the cryogenic cylinder 11. By generating heat within the cryogenic cylinder 11, the pressure within the cylinder 11 may be increased and used to motivate a cryogenic fluid within the cryogenic cylinder 11 to the dispensing valve 13 and out of the dispensing pipe 12.

The device 100 may comprise one or more cylinders 11 which may be suitable for storing and containing cryogenic liquids 200, such as nitrogen, carbon dioxide, oxygen, etc. Preferably, a cylinder 8 may be easily depressurized for safety precautions and/or pressurized to a relatively low pressure of approximately 25 pounds per square inch (PSI) allowing the cryogenic cylinder 11 to be used in areas of egress and retail. In preferred embodiments, a cryogenic cylinder 11 may comprise a double-walled vacuum vessel with multilayer insulation in the annular space, such as which may be used to house cryogenic liquids 200 such as liquid nitrogen. A cryogenic cylinder 11 may be configured in any shape, size, or capacity. In some embodiments, a cryogenic cylinder 11 may comprise a static cryogenic dewar and may have a cryogenic withdrawal device attached. In still further embodiments, a cryogenic cylinder 11 may be self-pressurizing and may therefore dispense cryogenic liquid 200 at a slower rate.

In yet further embodiments, a cryogenic cylinder 11 may comprise a cryogenic storage dewar that is a specialized type of vacuum flask used for storing cryogens (such as liquid nitrogen or liquid helium), whose boiling points are much lower than room temperature. Cryogenic storage dewars may take several different forms including open buckets, flasks with loose-fitting stoppers and self-pressurizing tanks. All dewars have walls constructed from two or more layers, with a high vacuum maintained between the layers as thermal insulation between the interior and exterior of the dewar, which reduces the rate at which the contents boil away. Precautions are taken in the design of dewars to safely manage the gas which is released as the liquid slowly boils. The simplest dewars allow the gas to escape either through an open top or past a loose-fitting stopper to prevent the risk of explosion. More sophisticated dewars trap the gas above the liquid and hold it at high pressure. This increases the boiling point of the liquid, allowing it to be stored for extended periods. Excessive vapor pressure is released automatically through safety valves. The method of decanting liquid from a dewar depends upon its design. Simple dewars may be tilted, to pour liquid from the neck. Self-pressurizing designs use the gas pressure in the top of the dewar to force the liquid upward through a pipe leading to the neck.

In some embodiments, the device 100 may comprise a dispensing valve 13 which may govern the ability of the contents within a cryogenic cylinder 11 to exit and/or enter the cryogenic cylinder 11. A dispensing valve 13 may comprise any device for controlling the passage of fluid or air through a pipe or duct, such as a flow control valve, pressure regulating valve, relief valve, ball valve, a gate valve, butterfly valve, diaphragm valve, globe valve, check valve, pressure balanced valve, locking valve, solenoid valve, or any other type of valve or controller which may be used to enable, disable, or otherwise govern the fluid communication of a cryogenic liquid 200 between the cryogenic cylinder 11 and a dispensing pipe 12. In some embodiments, a dispensing valve 13 may be a manually operated valve so that the valve may be manually opened or closed by a user. For example, when the cryogenic cylinder 11 is pressurized for the purpose of dispensing cryogenic liquid 200, the operator may open or close the dispensing valve 13, such as by turning left for on and right for off. Preferably, when the dispensing valve 13 is opened, cryogenic liquid 200 may flow through the dispensing pipe 12 and out of a phase separator 15 to produce a mist of cryogenic liquid 200 instead of a stream. In further embodiments, a dispensing valve 13 may be an automated valve so that the valve may be opened or closed without physical interaction of a user with the valve.

The device 100 may comprise a dispensing pipe 12 which may comprise a pipe or conduit through which a cryogenic liquid 200 can evenly flow out of the cryogenic cylinder 11 via a dispensing valve 13 to be distributed into another vessel. A dispensing pipe 12 may be configured in any shape and size. Preferably, a dispensing pipe 12 may be made from stainless steel or any other material suitable for conducting cryogenic liquids 200.

In some embodiments, the device 100 may comprise a phase separator 15 which may comprise a porous nozzle through which cryogenic liquids 200 may flow. In preferred embodiments, as cryogenic liquid 200 is dispensed out of a phase separator 15, the cryogenic liquid 200 may be separated into a mist or gentle stream of liquid, via the phase separator 15, to reduce splashing. Generally, a phase separator 15 may be coupled to a dispensing pipe 12 so that cryogenic fluid exiting the dispensing pipe 12 is forced through the phase separator 15 to produce a mist of cryogenic liquid 200 instead of a stream. This prevents splashing and supports consistent distribution of cryogenic liquid 200.

In further preferred embodiments, the device 100 may comprise a hood 16 which may be made from stainless steel or any other material suitable for contacting a cryogenic liquid 200 and may be configured to protect the phase separator 15 from impacts and damage. A hood may be configured in any size and shape which may be used to surround all or portions of a phase separator 15. Preferably, a hood 16 may comprise a generally conical shape which may be positioned around all or portions of the phase separator 15 to protect the generally delicate cryogenic phase separator 15 from damage and also to prevent splashing while dispensing.

The device 100 may comprise one or more heating elements 14 which may comprise a device for generating heat. In preferred embodiments, a heating element 14 may comprise an electric heating element which may convert electrical energy into heat. Generally, electric current passing through the heating element 14 encounters resistance, resulting in heating of the element 14. An electric heating element 14 may comprise one or more Peltier chips, metal heating elements, such as nichrome, Kanthal (FeCrAl), and the like, ceramic heating elements, such as molybdenum disilicide (MoSi2), polymer heating elements, such as PTC rubber, composite heating elements, such as fine coil of nichrome (NiCr) resistance heating alloy wire, that is located in a metallic tube (of stainless steel alloys, such as Incoloy, or copper) and insulated by magnesium oxide powder, and combination heating element systems, such as those using thick film technology, or any other device that converts electricity into heat. In other embodiments, a heating element may comprise a heat pump, a fuel burning device, or any other device or method for generating heat.

A heating element 14 may be positioned proximate to and/or in contact with a cryogenic cylinder 11 so that heat generated by the heating element 14 may be transferred or communicated, directly or indirectly, to a cryogenic liquid 200 within the cryogenic cylinder 11. In preferred embodiments, all or a portion of the heating element 14 may be positioned within a cryogenic cylinder 11 so that heat generated by the heating element 14 may be communicated directly to the contents of the cryogenic cylinder 11. In some embodiments, a heating element 14 may be a 220-volt electric heating element, a 110-volt electric heating element, a 12-volt electric heating element, or a heating element configured to operate with any other voltage or type of electric power. A heating element 14 may be disposed within the cryogenic cylinder 11 so that heat generated within the cryogenic cylinder 11 via the heating element 14 may increase the pressure or PSI within the cryogenic cylinder 11. In some embodiments, a heating element 14 may preferably be manually electronically controlled such that the heating element 14 may be turned on and off by either manually depressing an (optionally green LED) control input 45, such as a button, and/or the operator can allow the device 100 to automatically turn the heating element 14 on and off.

In some embodiments, the device 100 may comprise a cartridge protection pipe 17 which may surround all or portions of a heating element 14. In preferred embodiments, a cartridge protection pipe 17 may surround all or portions of a heating element 14 that are positioned within a cryogenic cylinder 11. In further embodiments, a heating element 14 may be situated inside of a cartridge protection pipe 17. When a heating element 14 situated or otherwise positioned inside of a cartridge protection pipe 17 (both of which are positioned within the cylinder 11) is electronically switched on, the heating element 14 may then heat the cartridge protection pipe 17 that is inserted within the cryogenic cylinder 11 thereby also heating the cryogenic liquid 200 inside of the cryogenic cylinder 11. This causes the liquid inside of the cryogenic cylinder 11 to evaporate and increase the liquid to gas conversion rate, which then results in an increase of pressure inside of the cryogenic cylinder 11. This pressure may be used to allow the operator to dispense the cryogenic liquid 200 by harnessing the pressure to propel the cryogenic liquid 200 out of the cryogenic cylinder 11 towards the dispensing pipe 12. A cartridge protection pipe 17 may be configured in any shape and size, such as cylindrical shape having a hollow interior into which portions of a heating element 14 may be received. A cartridge protection pipe 17 may be made for stainless steel or any other material suitable for contacting cryogenic liquids 200. Preferably, a cartridge protection pipe 17 may comprise a steel pipe that encases the portions of a heating element 14 disposed within a cryogenic cylinder 11 to protect the heating element 14 from contacting the contents of the inside of the cryogenic cylinder 11 that the cartridge protection pipe 17 is in inserted into.

In preferred embodiments, the device 100 may comprise a pressure reader 18 that may be configured to output information describing the pressure within the cryogenic cylinder 11. In some embodiments, a pressure reader 18 may comprise one or more electronic devices that may electronically measure and visually and/or electronically output the pressure information. For example, a pressure reader 18 may comprise a digital pressure reading device having one or more pressure displays 46A configured as light emitting diodes (LEDs) or a LED display screen, and the pressure reader 18 may display the pressure of the cryogenic cylinder 11 using the light emitting diodes (LEDs) or a LED display screen of the pressure displays 46A. In other embodiments, a pressure reader 18 comprise one or more analogue devices which may measure and visually and/or electronically output the pressure information.

In some embodiments, the device 100 may comprise a liquid level reader 19 which may comprise any device which may be used to measure the amount of liquid inside of a vessel, such as the amount of cryogenic liquid 200 within a cryogenic cylinder 11. In preferred embodiments, the device 100 may comprise a digital liquid level reader 19, optionally including a digital manometer, which may visually allow the operator to easily read how much cryogenic liquid 200 is present in the cryogenic cylinder 11 at any time. In other embodiments, a liquid level reader 10 may be configured to weigh the cryogenic cylinder 11 and use its weight to output or describe the amount of cryogenic liquid 200 within the cryogenic cylinder 11. In further preferred embodiments, the liquid level reader 19 may include an audible sounder or other alerting device, that may sound or otherwise alert an operator when the liquid level decreases to and reaches a desired level, such as the level of 49 mm or 7 Liters. This audible alert may serve to suggest to the operator that a refill should be implemented as soon as possible in order to continue the operation of dispensing cryogenic liquid 200 on demand.

In some embodiments, the device 100 may include a refill valve 21 which may be operated to allow cryogenic liquid 200 to be added to and/or removed from the cryogenic cylinder 11 independently from the dispensing valve 13 and dispensing pipe 12. A refill valve 21 may comprise any suitable type of valve suitable for use with cryogenic liquids 200. In further embodiments, the cryogenic cylinder 11 may be filled with a cryogenic liquid 200, such as liquid nitrogen, by connecting a standard cryogenic hose to the refill valve 21.

In some embodiments, the device 100 may include a relief valve 22. Generally, a relief valve 22 may comprise any device suitable for controlling the passage of fluid or air through a pipe when the user desires to decrease or increase of flow of escaping fluid or air from a vessel. A relief valve 22 may comprise any type of safety valve, such as a Pressure relief valve (PRV), Pressure Release valve (PRV), or pressure safety valve (PSV), that may be used to control or limit the pressure in the device 100 to prevent excessive pressure build up which may create a process upset, instrument or equipment failure, or fire. A relief valve 22 may enable fluid and/or gas to be diverted out of one or more elements of the device 100 so that excessive pressure inside an element of the device 100, such as the cryogenic cylinder 11 may be relieved or prevented. The operator may prepare the cryogenic cylinder 11 for pressurization by closing the relief valve 22. The operator may also use the relief valve 22 to depressurize the cryogenic cylinder 11 when not in use. In preferred embodiments, a relief valve 22 may be in fluid communication with a relief valve pipe 23 so that gas and/or fluid exiting the relief valve 22 may be directed by the relief valve pipe 23. Optionally, a relief valve pipe 23 may be bent at a curved, and optionally an approximately 90-degree, angle to direct the cryogenic venting away from the operator's face and toward the floor or surface upon which the device 100 is resting for the cryogenic liquid 200 or gas release.

In some embodiments, the device 100 may include a safety barrier 28 which may be aesthetically pleasing and optionally configured as a steel or other durable material box or container that surrounds all or portions of the cryogenic cylinder 11 and one or more other elements of the device 100. While in some embodiments, a safety barrier 28 may be configured with a rectangular prism shape that is large enough to surround or receive the cryogenic cylinder 11, in other embodiments, a safety barrier 28 may be configured with any other shape. Preferably, a safety barrier 28 can be painted and/or powder coated in a variety of colors, allowing the manufacturer to customize the look to the customer's requests.

In further embodiments, a safety barrier 28 may comprise an access door 25 which may be operably coupled to another portion of the safety barrier 28 via a movable coupling, such as a hinge, and/or via one or more fasteners, such as threaded fasteners. In preferred embodiments, an access door 25 of the safety barrier 28 may be locked via a door lock 26 with a key, keypad, or any other suitable locking method or device.

In some embodiments, to make the device 100 portable and easy to use in retail, catering or other professional settings, the device 100 may comprise one or more transportation conveyances 27 or other transportation conveyances which may facilitate moving the device 100 over surfaces, such as floor surfaces and ground surfaces. Preferably, four transportation conveyances 27 may be coupled to the safety barrier 28 and configured to support the safety barrier 28 on surfaces. Generally, transportation conveyances 27 may be configured to facilitate the movement of the device 100 across a surface by being configured to reduce the friction between the device 100 and the surface over which it is desired to be moved. A transportation conveyance 27 may comprise a wheel, a caster, a tread or track, a low friction pad or bumper, a low friction plate, a ski, a pontoon, or any other suitable device configured to reduce the friction between the device 100 and the surface over which it is desired to be moved.

In some embodiments, the device 100 may comprise a splash guard 29 which may be attached to the top of the safety barrier 28 or other location proximate to the dispensing pipe 12, dispensing valve 13, and/or phase separator 15 which may act as a barrier between the device 100 operator and customer or spectator. A splash guard 29 may be configured in any shape and size and may be made from any material suitable for contacting a cryogenic liquid 200. In preferred embodiments, a splash guard 29 may comprise a plastic or glass shield to protect the operator or spectator from splashing cryogenic liquids 200 and also to protect the contents on the surface of the device 100 from contamination.

In some embodiments, the device 100 may comprise a side table 31 which may be suitable for supporting objects. If the operator wishes, they can open or unfold the collapsible side table 31 by dropping down one or more legs 32 and optionally unscrewing the extending collapsible legs 32 to the desired height. This collapsible side table 31 is a bonus for operators to allow for extra materials to be used on the additional counter-space. A side table 31 may be configured in any shape and size, such as a generally rectangular shape. Preferably, a side table 31 may be movably coupled to the safety barrier 28 via a hinge, pivotal coupling, etc., and movable between an extended position 34 (for supporting objects) and a retracted position (for compact storage). Optionally, a side table 31 may be removably coupled to the safety barrier 28 via one or more fasteners or other removable coupling method. Generally, a side table 28 may be configured to extend to the side of the safety barrier 28 and to provide a level surface on which objects may be placed.

In some embodiments, the device 100 may comprise one or more legs 32 which may include a foot 35 for contacting a surface. Preferably, a leg(s) 32 may be extendable, retractable, or the like so that the foot 35 may be moved towards and away from the table to allow the leg 32 to be able to be folded into a small space to facilitate storage when the side table 31 is in a retracted position. In other embodiments, a leg 32 may comprise a fixed length. Preferably, one or more legs 32 may be movably coupled to the side table 31 with a hinge or other movable coupling. In further embodiments, one or more legs 32 may be removably coupled to the side table 31 with a removable fastener or other removable coupling. In further embodiments, the device 100 may comprise one or more leg braces 33 which may be removably or movably coupled to a leg 32 and side table 31 to further support the side table 31 and leg 32 when the side table 31 is in the extended position 34.

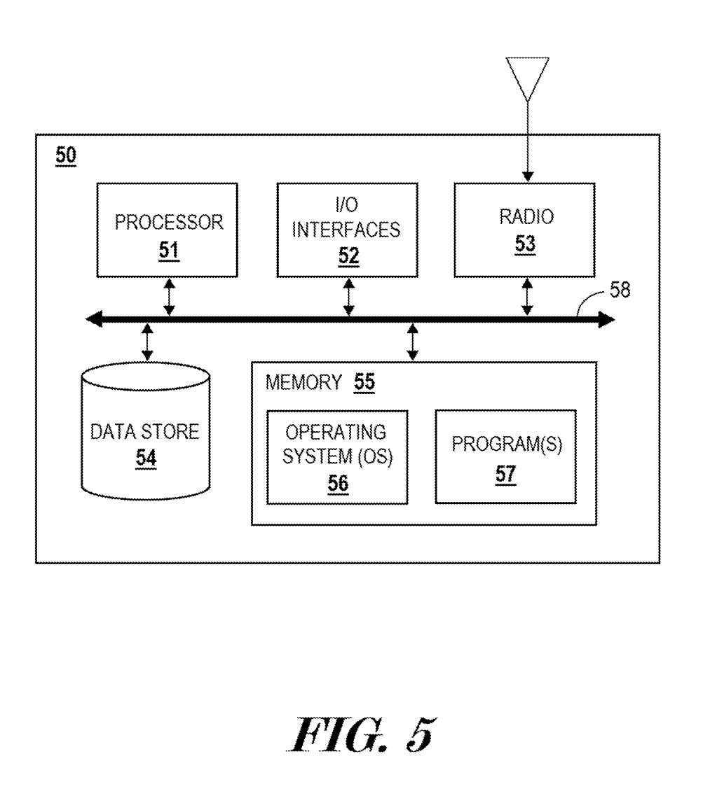

FIG. 5 shows a block diagram of an example of a processing unit 50 which may be an element of a cryogenic liquid dispensing device 100 according to various embodiments described herein. In some embodiments and in the present example, the device 100 can be a digital device that, in terms of hardware architecture, comprises a processing unit 50 which generally includes a processor 51, input/output (I/O) interfaces 52, an optional radio 53, a data store 54, and memory 55. It should be appreciated by those of ordinary skill in the art that FIG. 5 depicts the processing unit in an oversimplified manner, and a practical embodiment may include additional components or elements and suitably configured processing logic to support known or conventional operating features that are not described in detail herein. The components and elements (51, 52, 53, 54, and 55) are communicatively coupled via a local interface 58.

The processor 51 is a hardware device for executing software instructions. The processor 51 can be any custom made or commercially available processor, a central processing unit (CPU), an auxiliary processor among several processors associated with the processing unit 50, a semiconductor-based microprocessor (in the form of a microchip or chip set), or generally any device for executing software instructions. When the processing unit 50 is in operation, the processor 51 is configured to execute software stored within the memory 55, to communicate data to and from the memory 55, and to generally control operations of the device 100 pursuant to the software instructions. In an exemplary embodiment, the processor 51 may include a mobile optimized processor such as optimized for power consumption and mobile applications.

The I/O interfaces 52 can be used to receive and record environmental information, may comprise one or more expansion ports for additional sensors, to receive user input from a control input 23 and/or for providing system output through an indicator element 26. The I/O interfaces 52 can also include, for example, a serial port, a parallel port, a small computer system interface (SCSI), an infrared (IR) interface, a radio frequency (RF) interface, a universal serial bus (USB) interface, and the like.

An optional radio 53 enables wireless communication to an external access device or network. In preferred embodiments, a radio 53 may operate via WiFi communication standards. In further embodiments, a radio 53 may operate on a cellular band and may communicate with or receive a Subscriber Identity Module (SIM) card or other wireless network identifier. Any number of suitable wireless data communication protocols, techniques, or methodologies can be supported by the radio 53, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Near-Field Communication (NFC); Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

The data store 54 may be used to store data. The data store 54 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 54 may incorporate electronic, magnetic, optical, and/or other types of storage media.

The memory 55 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 55 may incorporate electronic, magnetic, optical, and/or other types of storage media. Note that the memory 55 may have a distributed architecture, where various components are situated remotely from one another, but can be accessed by the processor 51. The software in memory 55 can include one or more software programs, each of which includes an ordered listing of executable instructions for implementing logical functions.

In the example of FIG. 5, the software in the memory system 55 includes a suitable operating system (O/S) 56 and programs 57. The operating system 56 essentially controls the execution of input/output interface 52 functions, and provides scheduling, input-output control, file and data management, memory management, and communication control and related services. The operating system 56 may be, for example, LINUX (or another UNIX variant), Android (available from Google), Symbian OS, Microsoft Windows CE, Microsoft Windows 7 Mobile, iOS (available from Apple, Inc.), webOS (available from Hewlett Packard), Blackberry OS (Available from Research in Motion), Raspbian (available from the Raspberry Pi Foundation) and the like.

The programs 57 may include various applications, add-ons, etc. configured to provide end user functionality with the device 100. For example, exemplary programs 57 may include, but not limited to, cryogenic cylinder 11 variable analytics and modulation of heating element 14 and input/output interface 52 functions. In a typical example, the end user typically uses one or more of the programs 57 to control functions of the device 100 such as to control the amount of pressure within a cryogenic cylinder 11 via activating, deactivating, or otherwise modulating the heating element 14. In preferred embodiments, the processing unit 50 may be configured, via one or more programs 57, to cause the heating element 14 to generate heat, optionally for a desired time period, within the cryogenic cylinder 11 when the pressure reader 18 detects a minimum pressure, such as between approximately 10 PSI to 23 PSI, and preferably approximately 19 PSI, within the cryogenic cylinder 11. In further preferred embodiments, the processing unit 50 may be configured, via one or more programs 57, to cause the heating element 14 to stop generating heat within the cryogenic cylinder 11 when the pressure reader 18 detects a maximum pressure, such as between approximately 23 PSI to 30 PSI, and preferably approximately 25 PSI, within the cryogenic cylinder 11. Preferably, the processing unit 50 may be in communication with the heating element 14 via a power relay 42, such as a miniature electro industrial power relay, to allow a relatively low-voltage processing unit 50 to control a relatively high-voltage heating element 14.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The processing unit 50 may also include a main memory, such as a random-access memory (RAM) or other dynamic storage device (e.g., dynamic RAM (DRAM), static RAM (SRAM), and synchronous DRAM (SDRAM)), coupled to the bus for storing information and instructions to be executed by the processor 51. In addition, the main memory may be used for storing temporary variables or other intermediate information during the execution of instructions by the processor 51. The processing unit 50 may further include a read only memory (ROM) or other static storage device (e.g., programmable ROM (PROM), erasable PROM (EPROM), and electrically erasable PROM (EEPROM)) coupled to the bus for storing static information and instructions for the processor 51.

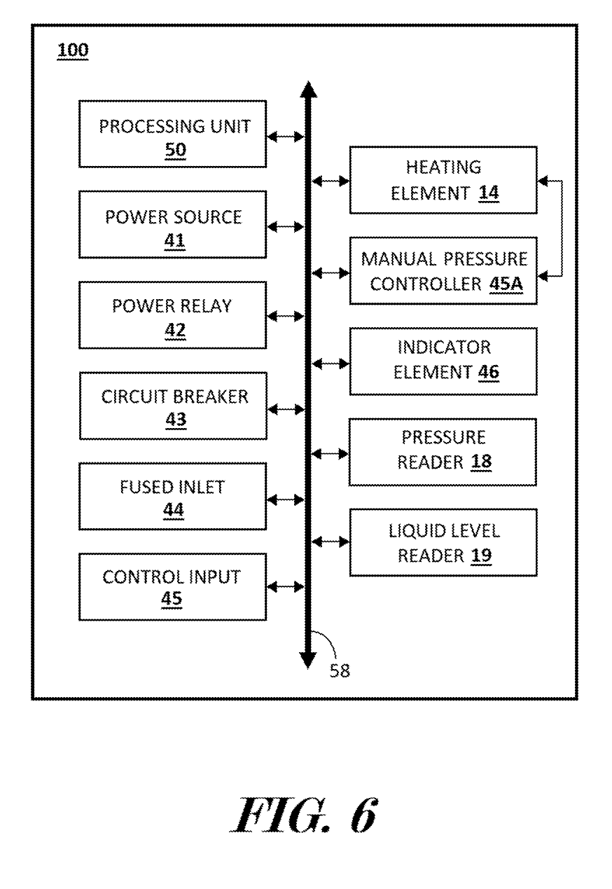

Referring also to FIG. 6, in some embodiments, the device 100 may comprise a power source 41 which may provide electrical power to any component that may require electrical power. Optionally, a power source 41 may comprise a battery, such as a lithium ion battery, nickel cadmium battery, alkaline battery, or any other suitable type of battery, a fuel cell, a capacitor, a super capacitor, or any other type of energy storing and/or electricity releasing device. In further embodiments, a power source 41 may comprise a power cord, kinetic or piezo electric battery charging device, a solar cell or photovoltaic cell, and/or inductive charging or wireless power receiver. In further embodiments, a power source 41 may comprise a power charging and distribution module which may be configured to control the recharging of the power source 41, discharging of the power source 41, and/or distribution of power to one or more components of the device 100 that may require electrical power. In preferred embodiments, a power source 41 may comprise an AC adaptor which may be used to connect to an external power supply, often enclosed in a case similar to an AC plug. AC adapters are used with electrical devices that require power but do not contain internal components to derive the required voltage and power from mains power.

In further embodiments, the device 100 may comprise one or more power relays 42 which may comprise a switch that opens and closes circuits electro mechanically or electronically. Generally, a power relay 42 may control one electrical circuit by opening and closing contacts in another circuit.

In still further embodiments, the device 100 may comprise one or more circuit breakers 43. Generally, a circuit breaker 43 may comprise a switch that automatically interrupts the flow of electric current if the current exceeds a preset limit, typically measured in amperes. Circuit breakers 43 are used most often as a safety precaution where excessive current through a circuit could be hazardous. Unlike fuses, they can usually be reset and reused.

In still further embodiments, the device 100 may comprise a fused inlet 44 which may be in communication with the power source 41 or integral to the power source 41. Generally, a fused inlet 44 may comprise an electrical device which may be used for controlling or conditioning the electrical input to an electrical apparatus and may connect to a power supply by means of a flexible cord and plug, appliance inlet or pins for engagement with a socket, that is attached to an electrical safety device that can stop current from flowing if it becomes overloaded.

In preferred embodiments, the device 100 may comprise one or more user control inputs 45 that a user may interact with such as turnable control knobs, depressible button type switches, a key pad, slide type switches, rocker type switches, or any other suitable input that may be used to modulate electricity between the processing unit 50, heating element 14, and/or other elements of the device 100. The control inputs 45 may be configured to control one or more functions of the device 100 such as to turn on or to turn off the heating element 14. Optionally, a control input 45 may comprise lighting elements, such as LEDs, which may be illuminated, preferably in one or more colors, to appraise the user on the status or condition of one or more elements of the device 100. For example, a control input 45 may be configured as an indicator button (e.g. a button or switch) that may be illuminated to provide specific information on the state or condition of state of something internally occurring, such as the heating element 14 generating heat. In preferred embodiments, the device 100 may comprise a control input 45 configured as a manual pressure controller 45A. A manual pressure controller 45A may comprise a button, switch, etc. which may be physically interacted with by a user to cause the heating element 14 to generate heat and to stop generating heat. Optionally, the manual pressure controller 45A may be in direct communication with the heating element 14 and/or indirectly in communication with the heating element 14 via the processing unit 50.

In some embodiments, the device 100 may comprise one or more indicator elements 46 which may be configured to visually and/or audibly apprise a user of the status of one or more elements of the device 100 and/or of one or more conditions that the device 100 is in. For example, if all elements of the device 100 are working properly, a light emitting type of indicator element 46, such as a LED light, may be operated by the processing unit to emit green light. As another example, an indicator element 46 may be configured to visually apprise a user of the status or charge level of the cryogenic cylinder 11. To provide visual information to a user, embodiments of an indicator element 46 can be implemented with one or more light emitting elements or other display devices, e.g., a LED (light emitting diode) display or LCD (liquid crystal display) monitor, for displaying information. Optionally, an indicator element 46 and a control input 45 may be combined together as a touch screen graphical user interface (GUI) or the like. In further embodiments, an indicator element 46 may be configured as a pressure display 46A which may digitally output the pressure within the cryogenic cylinder 11 as measured by a pressure reader 18. In still further embodiments, an indicator element 46 may be configured as a level display 46B which may digitally output the level of cryogenic liquid 200 within the cryogenic cylinder 11 as measured by a liquid level reader 19.

To provide audible information to a user, an indicator element 46 may be configured as a speaker or other sound emitting device. For example, when the fill level of the cryogenic cylinder 11 diminishes to a desired level, such as approximately 7 liters, at that level, an indicator element 46 configured a beeping sounder may be activated to audibly notify the user that the desired level or less than the desired level of cryogenic liquid 200 is present in the cryogenic cylinder 11. The beeping may provide a suggestion or reminder to the user or operator to refill the cryogenic cylinder 11 for continued operation.

In alternative embodiments, the device 100 may be configured as a non-electronic version that may include a self-pressurizing cryogenic cylinder 11 that uses a non-digital pressure reader 18 and a liquid level reader 19 configured as standard float level indicator and may be placed inside of a safety barrier 28 configured as a steel cabinet. Optionally, this version may not include or require a processing unit 50 or heating element 14 for regulating the cryogenic cylinder 11 pressure.

While some exemplary shapes and sizes have been provided for elements of the device 100, it should be understood to one of ordinary skill in the art that the cryogenic cylinder 11, dispensing pipe 12, heating element 14, safety barrier 28, optional side table 31, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the device 100 may be made from or may comprise durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or may comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A cryogenic dispensing device, the device comprising:
a cryogenic cylinder for containing a cryogenic liquid;
a dispensing pipe in fluid communication with the cryogenic cylinder;
a dispensing valve configured to govern the fluid communication between the dispensing pipe and the cryogenic cylinder; and
a heating element disposed within the cryogenic cylinder, the heating element configured to generate heat within the cryogenic cylinder to increase the pressure within the cryogenic cylinder.

2. The device of claim 1, further comprising a pressure reader.

3. The device of claim 1, further comprising a liquid level reader.

4. The device of claim 1, further comprising a cartridge protection pipe.

5. The device of claim 4, wherein the cartridge protection pipe surrounds a portion of the heating element that is disposed within the cryogenic cylinder.

6. The device of claim 1, further comprising a processing unit.

7. The device of claim 1, further comprising a fused inlet.

8. The device of claim 1, further comprising a manual pressure controller.

9. The device of claim 1, further comprising a phase separator.

10. The device of claim 9, wherein the phase separator comprises a hood.

11. The device of claim 1, further comprising a safety barrier supported by transportation conveyances.

12. A cryogenic dispensing device, the device comprising:
a cryogenic cylinder for containing a cryogenic liquid;
a pressure reader configured to detect a pressure within the cryogenic cylinder;
a dispensing pipe in fluid communication with the cryogenic cylinder;
a dispensing valve configured to govern the fluid communication between the dispensing pipe and the cryogenic cylinder;
a heating element disposed within the cryogenic cylinder, the heating element configured to generate heat within the cryogenic cylinder to increase the pressure within the cryogenic cylinder; and
a processing unit, wherein the processing unit is configured to cause the heating element to generate heat within the cryogenic cylinder when the pressure reader detects a minimum pressure within the cryogenic cylinder, and wherein the processing unit is configured to cause the heating element to stop generating heat within the cryogenic cylinder when the pressure reader detects a maximum pressure within the cryogenic cylinder.

13. The device of claim 12, further comprising a liquid level reader.

14. The device of claim 12, further comprising a cartridge protection pipe.

15. The device of claim 14, wherein the cartridge protection pipe surrounds a portion of the heating element that is disposed within the cryogenic cylinder.

16. The device of claim 12, further comprising a fused inlet.

17. The device of claim 12, further comprising a manual pressure controller.

18. The device of claim 12, further comprising a phase separator.

19. The device of claim 18, wherein the phase separator comprises a hood.

20. The device of claim 12, further comprising a safety barrier supported by transportation conveyances.
